(19) United States
(12) Patent Application Publication
(10) Pub. No.: US 2015/0254222 A1
(43) Pub. Date: Sep. 10, 2015

(54) METHOD AND APPARATUS FOR COBROWSING

(71) Applicant: XERZEES TECHNOLOGIES INC., Houston, TX (US)

(72) Inventor: Shahin SHADFAR, Orinda, CA (US)

(73) Assignee: XERZEES TECHNOLOGIES INC., Houston, TX (US)

(21) Appl. No.: 14/283,800

(22) Filed: May 21, 2014

Related U.S. Application Data
(60) Provisional application No. 61/949,194, filed on Mar. 6, 2014.

(51) Int. Cl. G06F 17/24; G06F 3/0482; G06F 17/30; H04L 29/06

(52) U.S. Cl. CPC G06F 17/241; H04L 67/42; G06F 3/0482; G06F 17/30861

(57) ABSTRACT

A method and apparatus for cobrowsing. The method can include establishing a cobrowsing session between at least a first computing device and a second computing device, wherein the first computing device and second computing device each include a cobrowser that can reflect interactions with and remain synchronized with the cobrowser on the other computing device; receiving a request at the first computing device to add a note associated with an object of a web page of the existing website; and assembling a message at the first computing device for the note, wherein the message includes identification information for the object and information regarding content of the note. The method can be used to add a note to a website in a cobrowser where the note may be viewable to multiple users in a cobrowsing session.

### CROSS-REFERENCE TO RELATED APPLICATION

This application claims priority to U.S. Provisional Application No. 61/949,194 filed Mar. 6, 2014, which is incorporated by reference in its entirety as though fully disclosed herein.

### FIELD OF THE INVENTION

The invention relates generally to cobrowsers and techniques to enhance accuracy and user-experience in cobrowsing environments.

### BACKGROUND

Cobrowsers have been used to enable two or more users to navigate the web in their respective browsers in a synchronized or somewhat synchronized fashion. While cobrowsers enable multiple users to view the same websites, they do not use desktop or screen-sharing techniques to enable viewing or interacting with a remote device. In the context of cobrowsing, the browsers are generally separate entities that follow each other.

There are a variety of challenges in cobrowsing technology. These challenges include keeping the separate browsers synchronized or at least partially synchronized, tracking actions of the remote browser, and maintaining a user-friendly environment for cobrowsing. There is a need for cobrowsing technology that solves one or more of these problems, as well as other problems with cobrowsing technology.

### SUMMARY OF INVENTION

One or more embodiments of the invention are directed to cobrowsers, methods for use in cobrowsing, or technology for use in cobrowsing. These embodiments are set forth in the detailed description in greater detail.

According to one embodiment, a method of the invention includes receiving a request at a browser to add a note associated with an object of a web page of the existing website; displaying the note on top of the object on the web page; and assembling a record for the note, wherein the record includes identification information for the object and information regarding content of the note, wherein the record is usable to reproduce the note on the web page of the existing website. The method can also include presenting a menu of notes for selection by a user, where the notes are at least partially customizable. The method can further include sending a message from the browser for use at a second browser, wherein the message comprises the record. This method allows, for instance, a user of one browser to add a note to an object of a website so that another user can view the website with the note either during real time during a cobrowsing session or at a later time.

Another embodiment is a method for establishing from a first computing device a cobrowsing session between at least the first computing device and a second computing device. In this embodiment, the first computing device and the second computing device each include a cobrowser that can reflect interactions with and remain synchronized with the cobrowser on the other computing device. The method includes receiving a request at the first computing device to add a note associated with an object of a web page of the existing website; and assembling a message at the first computing device for the note, where the message includes identification information for the object and information regarding content of the note. The method can also include sending the message to the second computing device to display the note above the object on the web page of the existing website.

Yet another embodiment of the invention is a method for processing a note for a browser. In this embodiment, the invention includes receiving a message from a first computing device for a note, wherein the note is associated with an object of a web page of the website and the message includes identification information for the object, information regarding content for the note, and an indication of one or more targeted users for the note; storing the message; and sending information from the message to at least one targeted computing device for a targeted user, wherein the information is sufficient to allow a browser installed on the target computing device to display the note above the object. The method can also include receiving a signal from the targeted computing device relating to a web page address, wherein the sending of the information from the message occurs in response to the signal. In this embodiment, the method can be performed, for instance, by a server that provides functionality for cobrowsing sessions.

The embodiments of the invention set forth herein can be implemented using software/program code to perform the described functions. For instance, the embodiments may use a machine-readable medium configured to cause the machine/processor to execute the methods set forth above.

### BRIEF DESCRIPTION OF THE DRAWINGS

The invention is illustrated in the figures of the accompanying drawings which are meant to be exemplary and not limiting, in which like references are intended to refer to like or corresponding part, and in which:

FIG. 1 is a block diagram illustrating the components in a cobrowsing environment in various embodiments of the invention;

FIG. 2 illustrates an embodiment for adding a note in the real-time cobrowsing mode and exemplary steps thereof;

FIG. 3 illustrates an embodiment where a menu of available notes is visible on a user device;

FIG. 4 illustrates an embodiment where a note overlays an object in a cobrowser;

FIG. 5 illustrates an embodiment of deferred mode for adding a note according to an embodiment of the invention;

FIG. 6 illustrates a flow diagram for an embodiment retrieving a note in deferred mode for adding a note;

FIG. 7 illustrates a menu that allows a user to add an object in a web page as a favorite item;

FIG. 8 illustrates a flow diagram for an embodiment to bookmark a favorite item;

FIG. 9 illustrates a thumbnail menu for selecting one or more favorite items;

FIG. 10 illustrates a flow diagram for recording the best screen orientation for cobrowsing and notifying another cobrowser of that orientation;

FIG. 11 illustrates an example of a notification of screen orientation to another user;

FIG. 12 illustrates the same website displayed in mobile view and in full desktop view;

FIG. 13 illustrates a flow diagram for the embodiment for determining the appropriate user-agent and generating the appropriate notification;

FIG. 14 depicts an embodiment for determining whether switching user-agents is necessary and where users default to using a mobile phone browser;

FIG. 15 illustrates an embodiment of a notification for switching user-agents;

FIG. 16 illustrates an embodiment of real-time navigation where a first cobrowser sends a message including a notification to a second cobrowser so that the user of the second cobrowser knows why the screen is changing in the manner caused by the first cobrowser;

FIG. 17 illustrates an embodiment for object identification in a cobrowsing environment;

FIG. 18 depicts an embodiment for object identification from change notification and replication;

FIG. 19 sets forth an example of a node in HTML code in an embodiment of the invention;

FIG. 20 sets forth an example of HTML code that may be executed by a second cobrowser according to one embodiment of the invention; and

FIGS. 21A, 21B, and 21C illustrate an example of state restoration at the start of a cobrowsing session on a second cobrowser.

### DETAILED DESCRIPTION

The proposed techniques, methods, and apparatus set forth herein are used in a software application known as a cobrowser. The type of interaction disclosed herein is not possible in existing web browsers, such as Safari, Chrome, or Internet Explorer, due to the security restrictions of these browsers.

According to some embodiments of the invention, the cobrowser application as an independent application will have control over its content and can therefore detect actions on one side and replicate those actions on connected cobrowsers. This does not compromise security and does not expose any personal information to cobrowsing companions or third parties. The synchronization can affect the addresses of web pages or URLs, scrolling actions, as well as actions on a web page such as filling out a form (checkbox ticking, text-field filling, etc.).

Numerous terms are used throughout this application, as set forth below, although these descriptions should not be considered to be limiting.

A device can be a personal computer, a mobile device such as a smart phone or a tablet, or any other computer-powered device.

A cobrowser or cobrowser application can be a software application installed on a device capable of (1) browsing websites with user interaction and (2) synchronizing website interaction for multiple users when connected.

A cobrowsing session can be considered to be established when at least two users are connected with each other, and when each user's cobrowser reflects actions taken by other users, therefore remaining synchronized with other cobrowsers.

Calling can indicate the action of one user requesting or inviting another user to join a cobrowsing session.

A friend can be a remote user of a cobrowser application and assigned as a “contact” that a user can call.

Real-time interaction can signify an action that is reflected for other users in a cobrowsing session within a few milliseconds or seconds.

A web page object, web object, or simply an object, can be an HTML object such as a link, an image, a checkbox, a text, or, in more technical language, a <div>, an <img> or an <input>. Various types of objects can be used within the scope of the invention.

A cobrowser server can be a back-end server computer or cloud-based server that facilitates communication between cobrowsers. It can contain one or more databases to store information on users and their actions.

The state of a cobrowser can be a collection of variables with their values defining the visible and sometimes invisible status of a cobrowser application. For instance, a state of a cobrowser can include: URL=http://www.someurl.com/somepage; vertical scrolling position=23% from top; checkbox with id=′mycheckbox′ ticked; etc.

An action can define a step taken by a user with regard to cobrowsing such as scrolling, clicking a checkbox, tapping on an object, or typing text in a text field.

A message sent from one cobrowser to another can be bundled data notifying the receiving cobrowser of the state of a web page on the sender cobrowser, or an action taken by the user on the sender cobrowser. A message is often hidden from users and is not, unless indicated, a chat message.

The embodiments of the invention set forth herein can be implemented using software/program code to perform the described functions. The embodiments may, for example, use a machine-readable medium configured to cause the machine/processor to execute the methods in the manners described herein. The machine-readable medium may be a non-transitory medium with instructions on it to carry out the features, methods, and techniques set forth below. For instance, the machine-readable medium can be implemented in a server to perform the process described herein for server features or may be implemented in a user device to perform features described herein for user devices and/or cobrowsers installed on user devices.

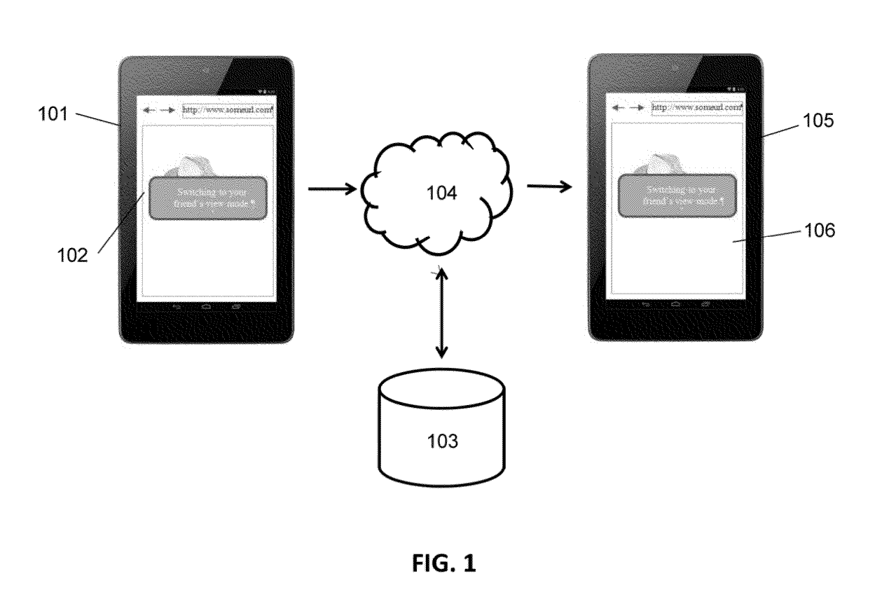

FIG. 1 is a block diagram illustrating the components in a cobrowsing session in one embodiment of the invention. User device 101 with an installed cobrowser may be any device, such as a mobile device, smart phone, or tablet. The device 101 can include memory of any type, such as a cache memory, flash memory, or other type of memory, to store instructions to perform the methods and techniques set forth herein. In some embodiments, a cobrowsing application 102 can be stored on the device 101, and the cobrowsing application 102 can have associated with it instructions for performing the methods and techniques set forth herein. Similarly, a comparably equipped second user device 105 may have a second cobrowser 106 installed. In addition, some embodiments can include a cobrowser server 103, which can be, as set forth above, a back-end server computer or cloud-based server that facilitates communication through a communications network 104 between cobrowsers such as cobrowsers 102 and 106. The communications network 104 can be, for instance, the Internet. The server 103 may contain one or more memories for databases to store information on users and their actions. The database can be used to store messages, notes, and/or additional information as set forth below. It can, for instance, have a machine-readable medium that is a non-transitory medium with instructions on it to carry out the features, methods, and techniques set forth herein.

Numerous embodiments of the invention are set forth below. The embodiments of the invention can be used separately or together. In addition, the disclosed subject matter is set forth in the following exemplary embodiments, but it is to be understood that numerous changes in the implementation details may be made without departing from the spirit and scope of the disclosed subject matter.

### 1. Adding Notes, Stickers for Friends Overlaid on Existing Websites

One embodiment of the invention relates to a method and apparatus for adding notes or stickers to an existing website for, for example, a friend. The proposed embodiments enable a user to overlay any textual or graphical note on top of objects within existing website pages for friends to see in either real-time or in a deferred mode. A note may contain, for example, text, drawings, images, animation, sound, highlighting (such as a circle or frame around an object), or any other visual or audible media. The note can, for instance, indicate that a user likes a product that is for sale so that another user can easily ascertain that fact from viewing the note.

a. Real-Time Mode

In one embodiment, a real-time mode connects friends within a cobrowsing session. In this embodiment, a user may add a note on top of an existing web page object while friends may immediately view (as a real-time interaction) or hear (when accompanied by a sound) the note.

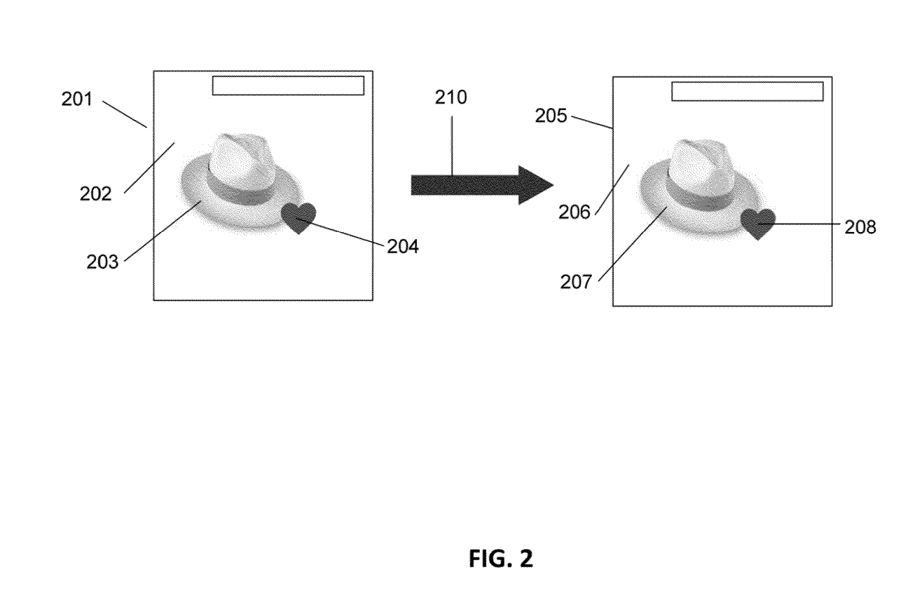

FIG. 2 illustrates an embodiment in the real-time mode and exemplary steps thereof. In FIG. 2, two friends are using cobrowsers 201 and 205 on separate devices to cobrowse a website for an online clothing store. The user of cobrowser 201 reaches a web page 202 of a hat that includes an image 203 of the hat. The user can overlay an image of a heart 204 on top of the image 203 of the hat to indicate that he or she loves the hat. During the cobrowsing session, the cobrowser 205 will follow the interactions of cobrowser 201 so that cobrowser 205 shows web page 206 that is the same as web page 202, as well as image 207 that is the same as image 203. When the user of cobrowser 201 adds the image of a heart 204 on top of the image 203, the cobrowser 205 will also display an image of a heart 208 on top of the image 207. Thus, the user of cobrowser 205 will immediately see the image of the heart 208 on the image 207 of the hat on the web page 206. In order to accomplish this, a message 210 including note information is sent from cobrowser 201 to cobrowser 205. The message 210 can be sent in a variety of ways, including email or text messaging, and the message 210 can also be sent through server 103 of FIG. 1.

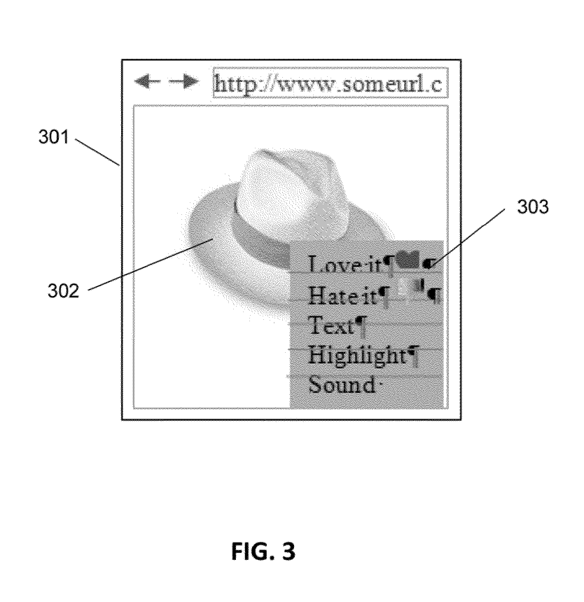

According to one aspect in this embodiment, a menu of available notes can be presented to a user when he or she wants to add a note. FIG. 3 illustrates an embodiment where a menu of available notes is visible on the user device. In this embodiment, the menu 303 appears in the cobrowser 301 upon selection of an object 302 by the user by, for example, pressing and holding on an object in a touch-screen enabled user device. Each note type may be predefined (for example, a heart image or a thumbs-down image) or customizable (for example, text) or partially customizable (for example, customizing the size of a predefined heart image). The text selection can allow the user to write custom text to accompany the note. As shown in FIG. 3, one note type can be a sound, which is a selection that can allow the user to record a sound to accompany the note.

When a user adds a note and wishes to send the note to one or more target users, a message (such as message 210 of FIG. 2) can be composed and sent to one or more other connected target users. The message can be sent, for instance, through server 103 of FIG. 1. The message may contain (1) identification information for the target object receiving the note, (2) information regarding the note type from a predefined list (e.g., image, text, animation, sound), (3) information regarding accompanying text (if applicable), (4) size information (if applicable), (5) color information (if applicable), (6) sound information (if applicable), (7) lifetime/duration of the note (if temporary), and (8) any other information required to render the note on a cobrowser. Receiving cobrowsers can use the target object identification information to find the object, then render the note using the information in the note message.

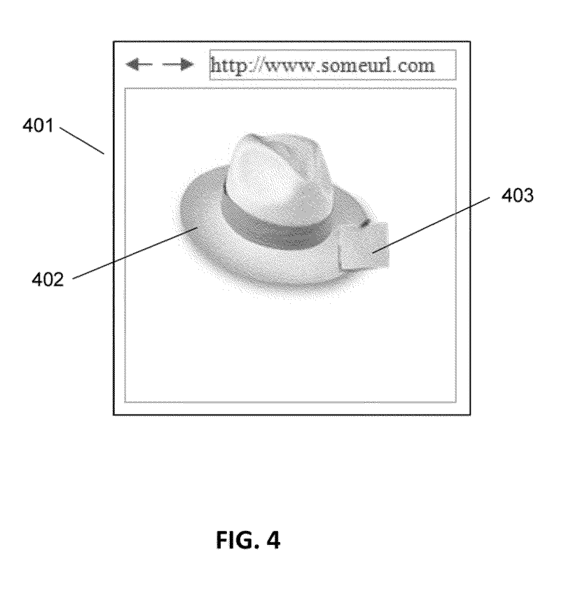

FIG. 4 illustrates an embodiment where a note 403 overlays an object 402 in a cobrowser 401. The depiction in FIG. 4 can be within either the cobrowser of the user who adds the note (i.e., after it has been added) or in the cobrowser of a second user who did not add the note (i.e., an indication for the second user that a note exists for viewing or listening). The note icon 403 appears to overlay the object 402 in the cobrowser 401. In this embodiment, the user may review the text/sound in the note by tapping on the posted note icon 403.

b. Deferred Mode

In deferred mode, an embodiment of the invention may include the ability to add one or more notes on the object(s) of one or more web pages even when disconnected from other cobrowsing users. This embodiment can also be used outside of the cobrowsing context and within browsers. This allows a first user to add one or more notes, send a notification for the notes to one or more other users, and then allow those other users to review the notes.

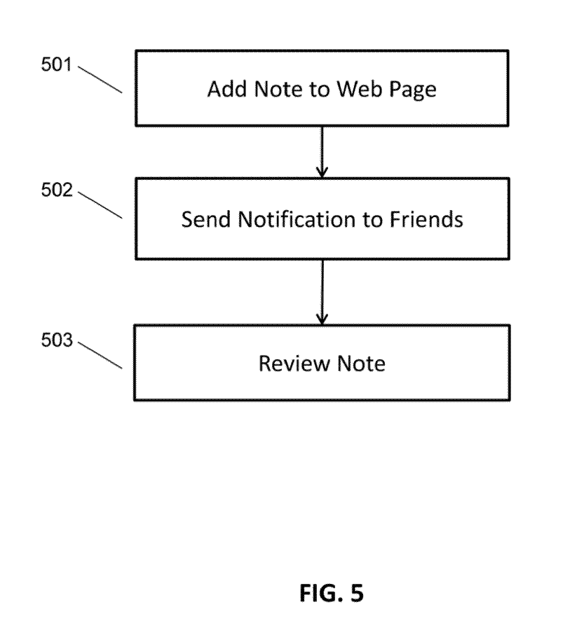

FIG. 5 illustrates an embodiment of the invention in this mode. In step 501, a user may navigate to a web page and add a note (e.g., a heart or a thumbs-down image) for an item they like. In step 502, the user may decide to share the notes with friends by sending them a notification via email, texting, an integrated messaging system to the cobrowser, or any other medium. In step 503, the notified friends may see (or hear) the note at a time of their choosing without being connected. A notified friend can view the note either immediately or several hours later. They may access the page by navigating to the web page themselves or through the notification.

In some embodiments, the user adding the note may decide not to notify any friends but still make the notes visible to all or a subset of friends. In some embodiments, in step 503, when a friend visits the same web page with the cobrowser, the note will be visible so they can see/hear the note.

In some embodiments, the menu used in the real-time mode set forth above can allow the user to add a note in deferred mode. In some embodiments, the user may share the note with a specific individual friend or make the note visible for all his/her friends or a subset of them.

Referring back to FIG. 1, when a user decides to add a note in deferred mode, a message with the necessary information can be sent from cobrowser 102 on user device 101 to the cobrowser server 103 through the communications network 104. If the user wishes to notify friends, a notification message may be sent to a friend's cobrowser 106 on the friend's user device 105. This message may enable the receiving cobrowser 106 to retrieve the web page and show the note when the receiving friend decides to view the note (which can be, for instance, at a later time). Thus, the user of cobrowser 102 can add a note while surfing the web and then share the note with other users for viewing/listening at a later point in time. Even if the user of cobrowser 106 is not active and using the cobrowser 106 when the user of cobrowser 102 adds the note, the user of cobrowser 106 can access the note at a later point in time, either upon receiving a message from the user of cobrowser 102 or upon using cobrowser 106.

A message similar to the real-time mode (above) can be composed to allow other users to view a note, and this message can include other information such as:

Web page address

Scrolling position

Date and time

Unique identifier of friend(s) to share with, and/or

A flag indicating whether to notify friend(s) or not

This message information can be, for example, stored within the database associated with server 103 of FIG. 1. Referring again to FIG. 1, in some embodiments, when targeted friend(s) connect to server 103 to see the note, the stored information is sent to their cobrowser 106, which goes to the web page containing the item and shows the note overlaid on the web page. Every time the receiving cobrowser 106 becomes active, it can check with the cobrowser server 103 to see if any new actions are available to process, such as new notes. If a note is available (made visible) for a friend, the receiving cobrowser 106 receives a message upon starting, meaning at the time the receiving cobrowser 106 becomes active. To reduce the amount of data, the message received by the cobrowser 106 from the server 103 about the note might not be the same complete message as the one composed by the sender using cobrowser 102 and sent to the server 103. A minimal message containing some information about the note is received by device 105 and saved locally to the list of notes. For example, the minimal message can include data such as the sender's name or ID and web page identification information along with the note. Thus, the message ultimately delivered to the cobrowser 106 may contain only some of the information from the message sent to the server 103 by the cobrowser 102 through which the note was originally created.

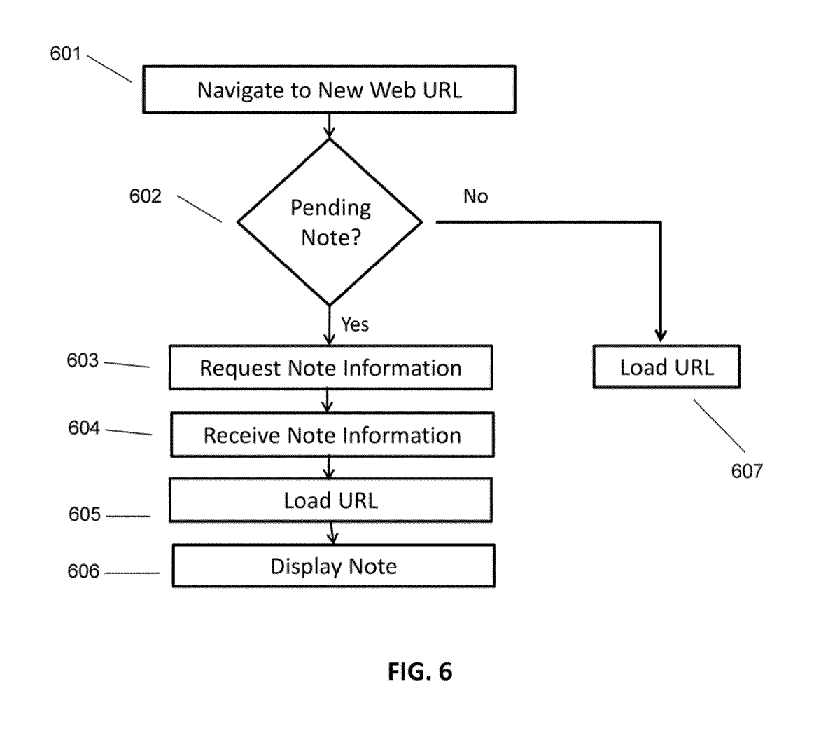

FIG. 6 illustrates a flow diagram for an embodiment retrieving a note in deferred mode. As shown in step 601, the receiving user device navigates to a web page URL. In step 602, when the receiver visits any web page, the cobrowser 106 can check the address against the local list of pending notes at the server 103 to see if a pending note exists. In step 603, if a note should be displayed on a given web page, the cobrowser 106 requests full note information from the cobrowser server 103. Upon reception of the full data in step 604, the cobrowser 106 loads the web page in step 605 by, for example, loading the URL, and displays the note for the user as shown in step 606. Where there is no pending note, the web page is loaded by loading the URL without further computation as shown in step 607.

In some embodiments, users may decide whether to add a note in real-time (e.g., available immediately) or make the note available for deferred mode.

Accordingly, in the deferred and real-time modes, embodiments of the invention can be a method for adding a note to an existing website. In one embodiment, this method can be performed by one browser, such as cobrowser 102 of FIG. 1. This method can include receiving a request at a browser to add a note associated with an object of a web page of the existing website, displaying the note on top of the object on the web page, and assembling a record for the note. The record can include identification information for the object and information regarding content of the note, where the record is usable to reproduce the note on the web page of the existing website. The record can be saved for later use by either the same browser or by a different browser at a different point in time. Alternatively, the record can be delivered in a message from a first cobrowser to a second cobrowser in real-time so that the second cobrowser can recreate in real-time the note over the same existing website during a cobrowsing session.

In addition, the server 103 of FIG. 1 can perform a method for using a note for a website. In this embodiment, the server can receive a message from a first computing device for a note, where the note is associated with an object of a web page of the website, and where the message includes identification information for the object, information regarding content for the note, and an indication of one or more targeted users for the note. The server can then store the message and, either in real-time or at a later point in time, send information from the message to at least one targeted computing device for a targeted user, wherein the information is sufficient to allow a browser installed on the target computing device to display the note above the object.

### 2. Favorite Items

In one embodiment, the method and apparatus according to the invention creates favorite links or bookmarks in a web browser to objects within a given web page, rather than links to web pages only. This embodiment enables users to create a collection of items as opposed to a collection of web pages, which orients the bookmarking around items rather than web pages. For example, a user may want to add an image of a hat in a given web page to a list of favorite items and be able to retrieve it directly at a later time. Even though the image of the hat is positioned deep within the web page, upon selecting the favorite item, a browser may load the page and directly scroll to the exact position to highlight the image.

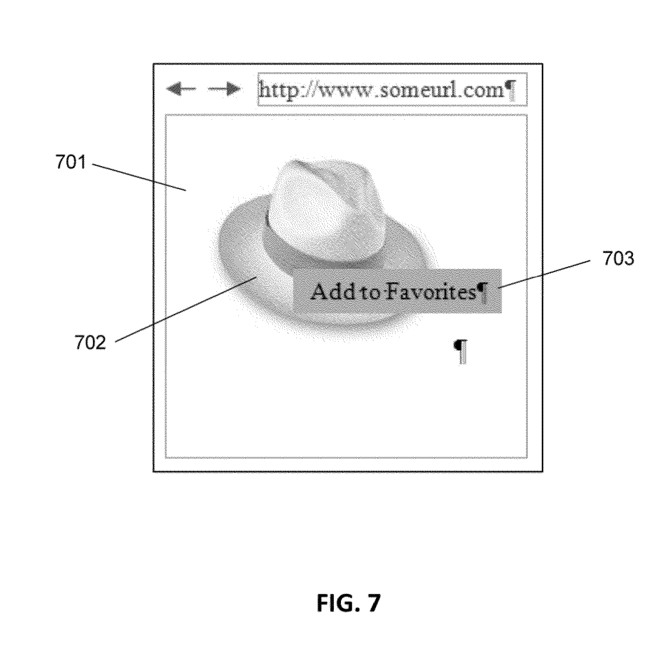

FIG. 7 illustrates a menu that allows a user to add one or more objects in a web page as favorite items. As shown in FIG. 7, a menu option 703 may appear upon selection of item 702 in web page 701. Menu option 703 may allow the item 702 to be added to a list of favorite items. In other embodiments, the menu option 703 can include additional selection options so that the user could, for example, add a particular type of note or select an indication of a favorite item.

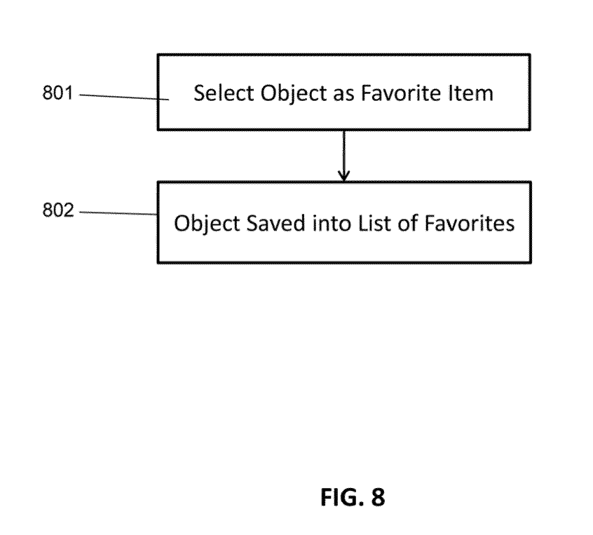

FIG. 8 illustrates a flow diagram for this embodiment to bookmark a favorite item. In step 801, a user may select an object in a web page as a favorite item, as set forth in connection with FIG. 7. In step 802, the object is saved into the list of favorite items. When saving an object into the list of favorite items, object identification information can be saved locally in the user device, which may include web page address (URL), object information, and relative scrolling position. In some embodiments, the object identification information may also be communicated to a server (such as server 103 of FIG. 1) and entered into a database. Using the server, favorite items may be retrieved on other devices.

In some embodiments, in order to retrieve the item at a later time, the user can select the item from a thumbnail list. Upon selection of a favorite item, the browser may load the web page, scroll to the item's position, and optionally highlight the item.

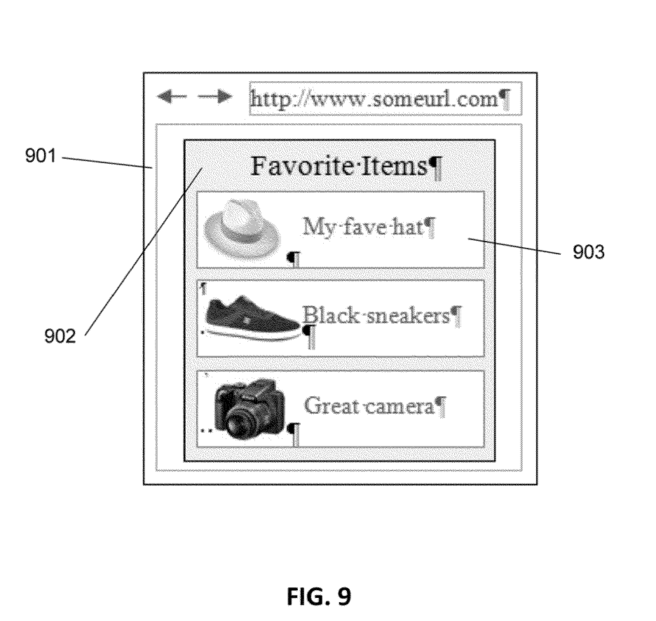

FIG. 9 illustrates a thumbnail menu 902 for selecting favorite items in one embodiment. As shown in FIG. 9, the cobrowser 901 may display a thumbnail menu 902 that allows the user to choose to navigate to items on the list of favorites, such as item 903 (“My fave hat”). Upon the selection of a particular item (such as item 903) in the menu 902, the cobrowser 901 will navigate to the selected favorite object on the web page.

In some embodiments, the proposed method and apparatus may be applied in a cobrowser. In another embodiment, the proposed method and apparatus may be applied to a standard (non-cobrowsing) web browser.

### 3. Best Screen Orientation Notification and Status

During a cobrowsing session, different users may be using different devices with various screen sizes. As an example, one user may be using a smartphone while another user may be cobrowsing on a tablet or other mobile device with a larger screen. Complications may arise where screen sizes affect the viewable area of the cobrowser running on different user devices. Further complicating the problem, users may also hold their devices differently, based on their habits. Rotating a mobile device into portrait mode, for instance, lessens the screen width in comparison to landscape mode.

In one embodiment, the proposed method and apparatus relates to recording the best screen orientation for cobrowsing and notifying another cobrowser of that orientation. The embodiment provides notifications to connected users by suggesting that a user rotate his/her user device in order to have the cobrowsing devices match orientation and create a better user experience.

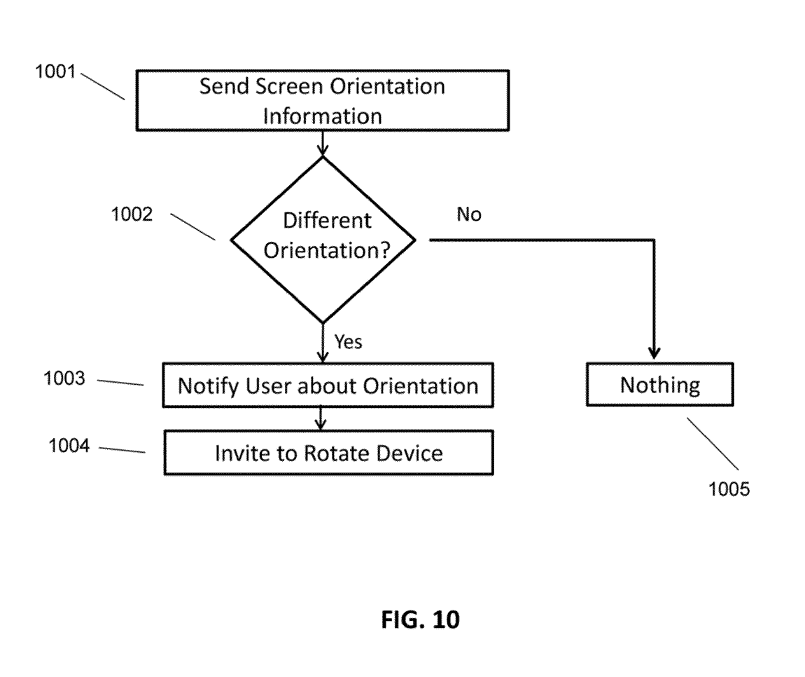

FIG. 10 illustrates a flow diagram for the embodiment for recording the best screen orientation for cobrowsing and notifying another cobrowser of that orientation. As shown in step 1001, upon connection into a session, each user sends information relating to their screen orientation to the other user(s). At the start of a session or when receiving a screen orientation message, each device having a cobrowsing session updates the orientation of other user(s) in its local database. In some embodiments, a preferred orientation may be chosen. This preferred orientation may be, for example, the landscape orientation.

According to one embodiment, during a cobrowsing session, when a user changes his/her screen orientation, the information is forwarded to other cobrowsing users. According to one embodiment, mobile devices raise events (notify) when their screen orientation is modified by user interaction.

As shown in step 1002, if the user's orientation differs from at least one other user, a temporary notification is sent to the cobrowser that (1) notifies the user that his/her screen orientation is different from another user in the cobrowsing session as shown in step 1003, and (2) invites him/her to rotate his/her user device for a better cobrowsing experience as shown in step 1004. If the screen orientation of all cobrowsing users is the same, no action will be taken by individual cobrowsers to change screen orientation, as shown in step 1005.

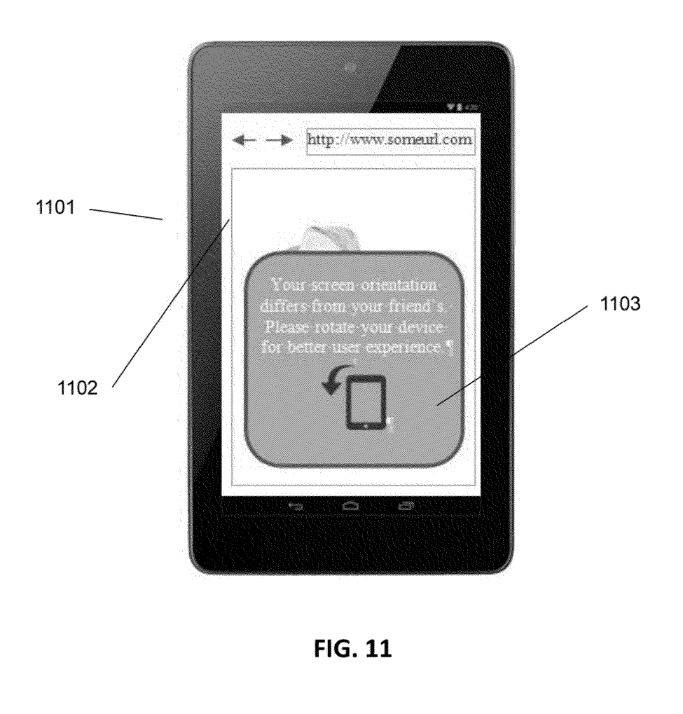

FIG. 11 illustrates an example of such a notification of screen orientation to another user. As shown in FIG. 11, the cobrowser 1102 may show an onscreen notification 1103 to the user to instruct him/her to rotate user device 1101 for a better viewing experience.

In an embodiment with a preferred orientation, for example, if any users' screen orientations differ, the system will notify the user(s) with the non-preferred orientation (e.g., the user in portrait mode where landscape is preferred), allowing that user or users to change screen orientation.

If the orientations of the user devices (whether in landscape or portrait) are identical, then no notification will be performed. If the orientation of one user device differs, a notification is shown only to the user device using the non-preferred orientation.

### 4. Best Browser User-Agent Switching

Another embodiment relates to selecting the best browser view for cobrowsing. In a cobrowsing session, different users may be using different devices with various screen sizes. As an example, one user may be using a smart phone while another user is on a larger screen tablet mobile device.

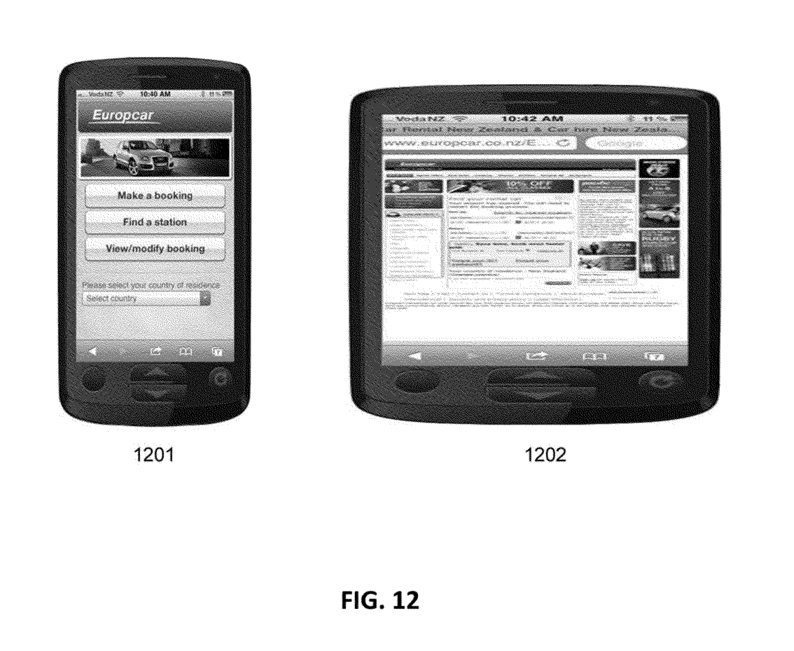

FIG. 12 illustrates the same website displayed in mobile view and in full desktop view. User device 1201 shows a website in mobile view on its browser. User device 1202 shows a website in desktop view on its browser.

When connecting to web servers, browsers present a “user-agent” telling the server what type of device, operating system, and browser they are using. Based on the user-agent, the web server presents HTML code to display as pages in browsers. For example, mobile format pages are served when the web server detects a smart phone as opposed to serving full-version (regular personal computer format) pages.

In a cobrowsing environment, it is critical to present similar screens to all connected users. If one user is viewing the full web page version (sometimes referred to as the “desktop version”) while another is viewing the mobile web page version, it will be challenging to mirror items and interactions on them. For example, a first user with a full desktop view may be viewing an image on a web page that does not even exist in the mobile view of the web page viewed by a second user. For this reason, the cobrowsers of the first and second users must coordinate and select the same type of user-agents so the views are synchronized (i.e., both cobrowsers view the page in either the mobile view or full desktop mode).

The method and technique according to this embodiment enable cobrowsers to choose a user-agent at the time of connection (upon accepting a cobrowsing call) based on one or more other device's formats. For example, if two users are both on iPads, they both present the regular iPad user-agent, but if one user is on an iPhone and the other user is on an iPad, they both need to switch to the iPhone user-agent so they see the same mobile format version of websites.

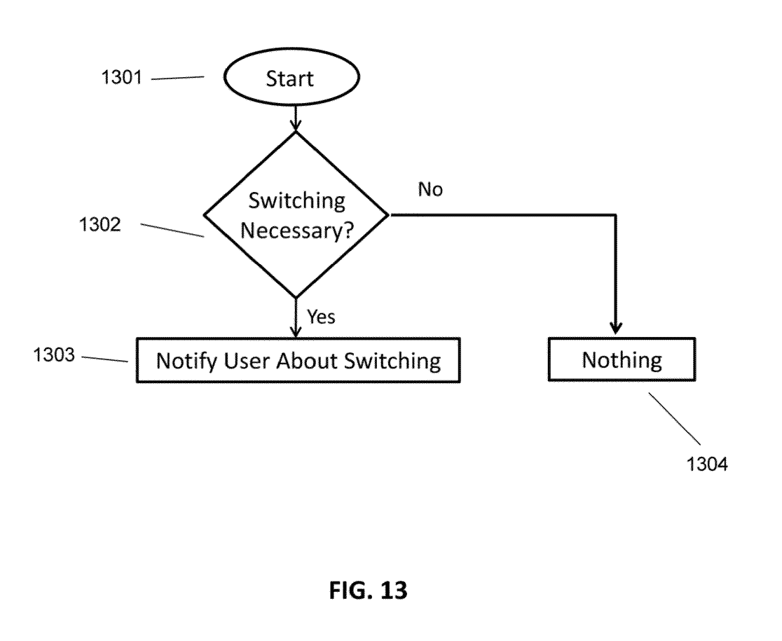

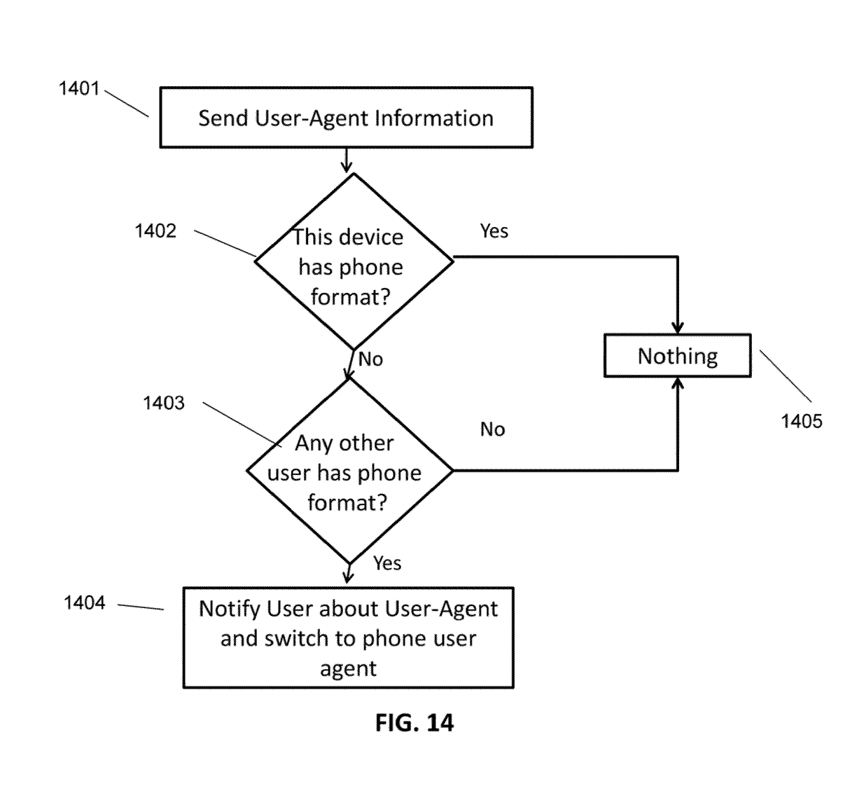

FIG. 13 illustrates a flow diagram for the embodiment for determining the appropriate user-agent and generating the appropriate notification if needed. After the start of the method in step 1301, the method may determine whether switching to a different user-agent is necessary, as shown in step 1302 and described in greater detail in connection with FIG. 14. As shown in step 1303 of FIG. 13, if a better user agent is appropriate, a notification may be displayed telling the user that his/her screen is switching to the preferred user agent, such as mobile mode (or another commonly available format) for a better cobrowsing experience. Alternatively, when a switch is not appropriate, no notification is sent, as shown in step 1304.

FIG. 14 illustrates an embodiment for determining whether switching user-agents is necessary and where users default to using a mobile phone browser. As shown in step 1401, when connecting to a cobrowsing session, users may send information about themselves and their environment to the other users. As shown in steps 1402 and 1403, upon reception of the information, each device may determine whether switching to a different user-agent is possible and necessary. In step 1402, if an individual user's device is a phone-format device (that is, smaller), no change is necessary (other devices, if larger, typically must adapt to the smaller format). If, however, the individual user's device is not a phone-format device, the next step in the processing is performed in step 1403. In step 1403, if another user's device is using a phone format, then it may be necessary for the individual user's device to switch formats. Hence, in step 1404, if the individual user's device is not a phone format device and if another user has a phone format device, the individual user's device will be notified about a change in format and the individual user's device will be switched to the phone format. If, on the other hand, step 1403 reveals that no other user is using the phone format, then no change will be necessary, as shown in step 1405. If no switching is necessary, no notification will be issued, as shown in step 1405.

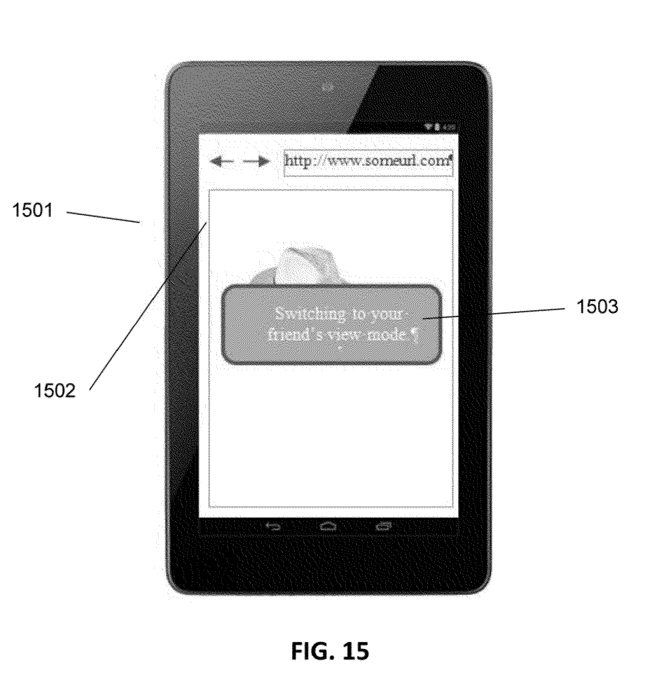

FIG. 15 illustrates an example of such a mode-switching notification. As shown in FIG. 15, cobrowser 1502 of user device 1501 may display a notification 1503 to indicate that the view mode will be changing to a friend's view mode (i.e., a connected cobrowser's view mode). In this embodiment, user device 1501 can be a larger mode device that needs to switch to a phone-format viewing mode.

### 5. Real-Time Navigation Notification

Another embodiment of the invention relates to real-time navigation notification to users in a cobrowsing environment. In a cobrowsing environment, communicating a user's actions to other connected users leads to better user experiences. When a user clicks or touches the back button, for instance, the browser starts loading the previous page. The cobrowser notifies the other connected cobrowsers to also load the previous page, but since the other users have not seen the first user's action (the action of clicking the back button), they might be confused as to what happened and why another page is being loaded.

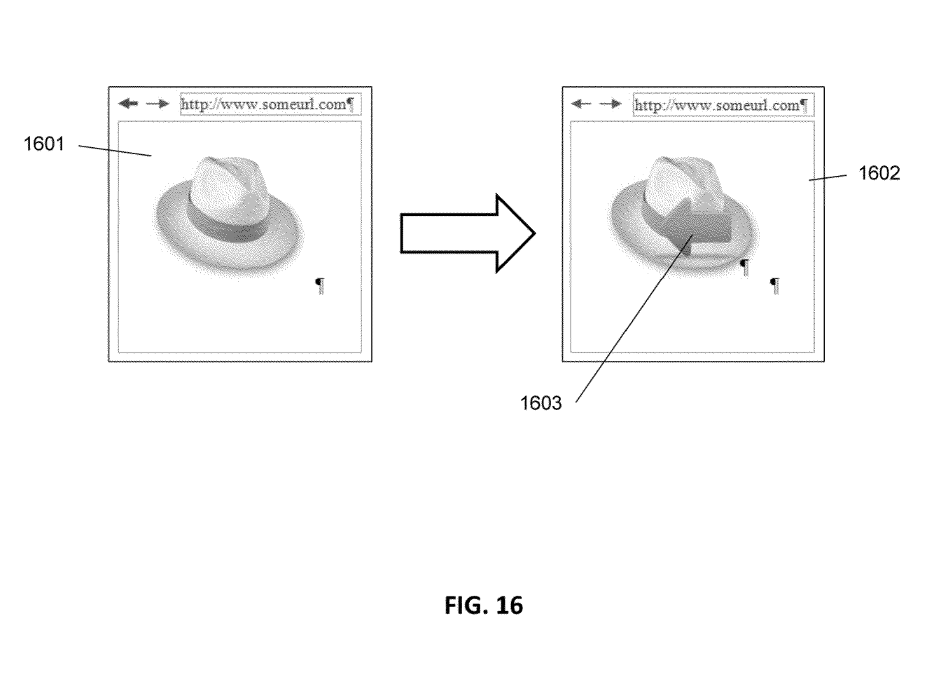

The proposed method and apparatus can display a message, indication, or sign on another user's interface showing him/her what is about to happen in the cobrowsing session. FIG. 16 illustrates an example of real-time navigation where a first cobrowser 1601 sends a message including a notification 1603 to a second cobrowser 1602 so that the user of the second cobrowser 1602 knows why the screen is changing in the manner caused by the first cobrowser 1601. In this example, the second cobrowser 1602 notifies the second user with notification 1603 (an arrow to the left) when the first cobrowser 1601 navigates to a previous page in response to the first user clicking on the back button in the first cobrowser 1601. This illustrates to the second user why the previous page will be displayed.

Every time a navigation event is detected, it is sent to other connected users as part of the cobrowsing mechanism. Thus, when an event occurs causing a page change or other changes such as scrolling or clicking on a button, the receiving user sees one or more graphical signs helping him/her understand the action. On the receiver side, a graphical sign is displayed over the page for a limited period of time. For example:

A left arrow is displayed indicating backward navigation

A right arrow is shown for forward navigation

A circular recycle sign is shown to indicate reloading of a page

A hand cursor is displayed moving from top to bottom to imply scrolling

An animation of a click with a cursor is shown to specify clicking on a link or button

### 6. Object Identification Technique in a Cobrowsing Environment

When an object in a cobrowser is selected in order to tag notes, icons, or text, the sending cobrowser must identify the object and inform the receiving cobrowser of the tag. In order for the receiving cobrowser to properly tag the object, the receiving cobrowser must identify the proper web object. This embodiment of the invention relates to a method and apparatus for identifying the correct web object by the receiving cobrowser based on information received from the sending cobrowser. The technique and method enhanced by this embodiment is based on change detection on one side, and replication on the other side.

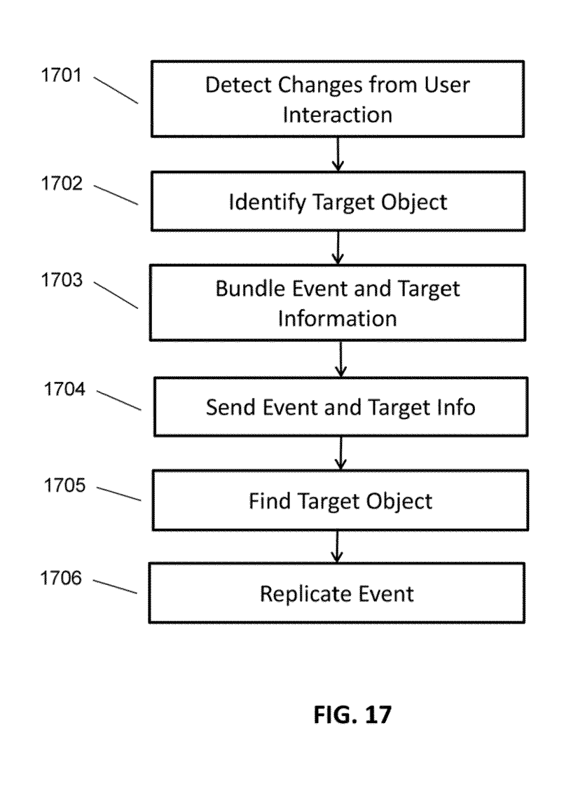

FIG. 17 illustrates an embodiment for object identification in a cobrowsing environment. In step 1701, the embodiment detects changes caused by user interaction in the cobrowser. In some embodiments, the detection may be implemented either at the browser native code level or at the Javascript level in order to listen for events such as a URL change, scrolling, clicks on links, checkboxes, etc. For example, in the Javascript programming language, one may add “event listeners” for click events on the “document” object. When a user clicks a link, the cobrowser can be notified and be provided with the target object of the click event.

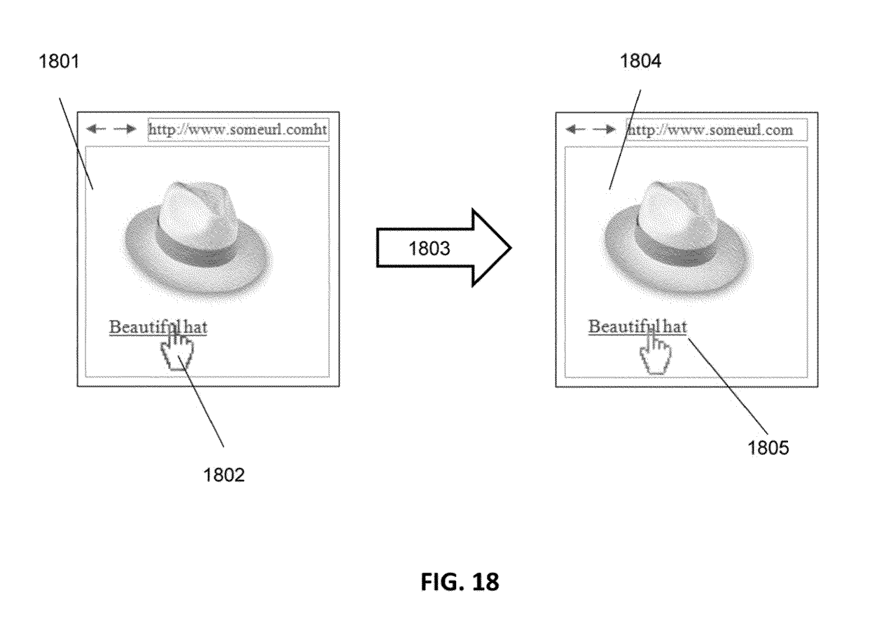

Referring briefly to FIG. 18, this figure illustrates an example of an embodiment for object identification from change notification and replication. As shown in FIG. 18, the cobrowser 1801 may detect a user's selection of link 1802.

Referring again to FIG. 17, in step 1702 the embodiment identifies the target object and determines the web object that was the target of the action or event. For example, this may involve identifying a link that was clicked or a checkbox that was ticked.

In step 1703, the embodiment may collect the information about the event and the target object. In some embodiments, this may involve creating a signature or identifier of the target object.

In step 1704, the embodiment may send the event and target information to a receiving cobrowser. In some embodiments, this may involve creating and sending a message with the event and target information. The message is illustrated as 1803 in FIG. 18.

In step 1705 in FIG. 17, the embodiment may find the target object on the receiving cobrowser. In some embodiments, this may involve locating the object in the displayed page.

In step 1706, the embodiment may replicate the user event from the cobrowser in a second cobrowser. In some embodiments, this may trigger the same event on the target object based on event information. The replication step is illustrated in FIG. 18 as the replication of link 1805 in the receiving cobrowser 1804.

In an embodiment of a sending cobrowser, the invention applies to any given website and any existing HTML composition. In that embodiment, useful information on the target object may be gathered and organized during step 1703 so that the receiving browser may retrieve the HTML object located in step 1705.

This embodiment may be complicated by the fact that, in some applications, the HTML content of the same web page may be slightly different, based on many factors such as geographical location. For example, Google search results may be ordered differently for two different people. When the first user clicks on a link to a search result, the embodiment may be able to locate that link on the second user device, even when the search results may not be in the same order.

In some embodiments, more data regarding the web object may be retrieved using a recursive algorithm by the receiving browser in order to locate the correct target object. In some embodiments, a path may be recursively traced between the target object and the <BODY> object by tracing up to the “parent” object at each step. Any such object on the path is commonly referred to as a “node” in the HTML language. The following information can be collected for each node on the path:

Node tag name, e.g., “DIV”

Node order among its parent's children, e.g., DIV being the 5th child of its parent

Node number of HTML attributes

The list of attributes with their values

Text in the object, if any

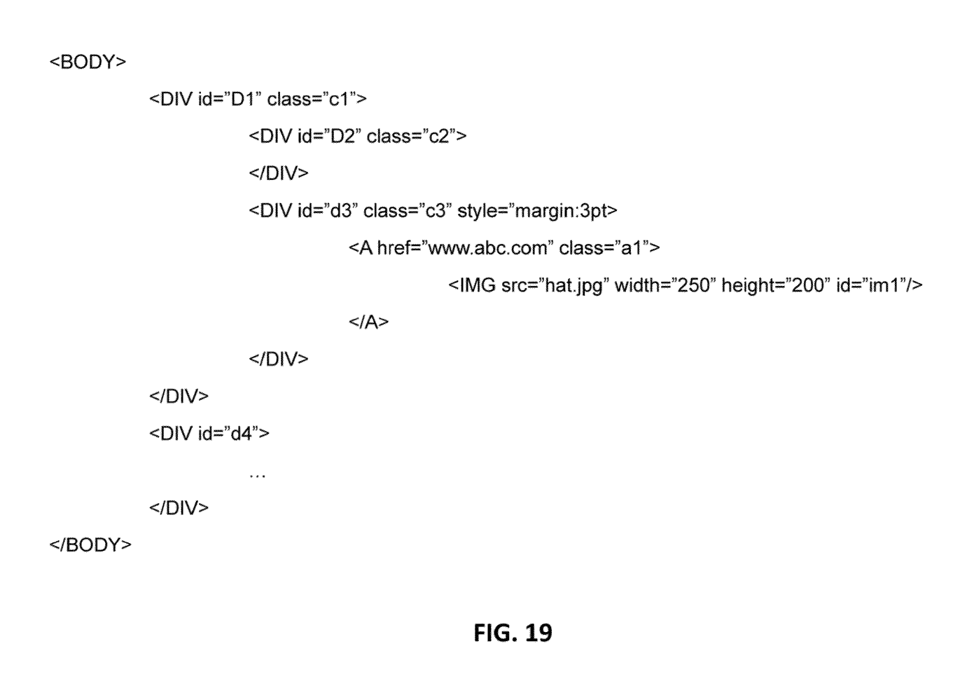

FIG. 19 sets forth an example of a node in HTML code in an embodiment of the invention. An embodiment of the invention may collect information from the information tagged <BODY> for each node on its path. Using the HTML code in FIG. 19, an embodiment of the current invention may create a path starting with <BODY> and ending with the target object. The collected information may be shown below:

```
• Node 1
    ∘ Tag name = DIV
    ∘ Order = 1
    ∘ Number of attributes = 2
    ∘ Attributes
        ▪ Id = d1
        ▪ Class = c1
    ∘ Text = ″ ″
• Node 2
    ∘ Tag name = DIV
    ∘ Order = 2
    ∘ Number of attributes = 3
    ∘ Attributes
        ▪ Id = d3
        ▪ Class = c3
        ▪ Style = ″margin:3pt″
    ∘ Text = ″ ″
```

In the example above, the path has two nodes, with the second (last) node being the target object. With respect to the target object, more information may be collected regarding (1) the number of children and (2) the list of children with their lists of attributes and values.

For the example above, the additional information for the target object is:

```
• Number of Children = 1
• Children:
  ∘ Tag name = A
  ∘ Number of attributes = 2
      ▪ Href = ″www.abc.com″
      ▪ Class = a1
```

For faster transmission, in some embodiments, the data may be compressed and optionally encrypted for security purposes and sent to other users. In some embodiments, when the target object information is received by another cobrowser, it may be decrypted and decompressed and, hence, presented as a path of nodes.

In some embodiments, the invention reviews the contents of the <BODY> object, runs through children trees guided by the “node order” information, and assigns different scores to different paths based on the number of matching attributes and values. Upon completion, the chosen path contains the highest score and leads to the target object.

In some embodiments, the search path is identical on the sender's cobrowser. When the score is 100%, there is no need to review other paths and the search concludes quickly. Traversal of other search paths is necessary only when the score is below 100%.

The following segments of code are examples of JavaScript that constitute the core engine of the target object retrieval process in certain embodiments. As part of a recursive search process, the coded functions may call themselves many times at every retrieval occurrence.

Definition of the PathNode object class:

```
PathNode.prototype =
{
  ′elem′: null,
  ′nodeName′: null,
  ′index′: null,
  ′attrs′: null,
  ′text′: null,
  ′nextNode′: null,
  ′children′: null,
  ′maxScore′: null,
  ′childDepth′: 0
};
```

When a cobrowser receives information about a target object, it may de-serialize the data into a PathNode object, which creates a linked chain of nodes. De-serializing is a known technique to a person of ordinary skill in the art. The getBestMatchRecord function may be called with the PathNode object and null (for startContainerElement) as arguments.

```
  Function getBestMatchRecord = function (pathNode, startContainerElement)
  {
    // initialize it with the BODY object on first call
    if (!startContainerElement)
      startContainerElement = document.getElementsByTagName('BODY') [0];
    // Get all children of the container
    var siblingElements = startContainerElement.children;
    // Get Create an empty result record
    var bestPathNodeRecord =
    {
      ′bestElem′: null,
      ′score′: -1
    };
    // Go through children by starting with the element at
    // pathNode.index and then going up and down from there
    // if we have not found the maxScore (100% score)
    for (var i = 0;
    i + pathNode.index <siblingElements.length | | pathNode.index - i >= 0;
    i++)
  {
    // Go up or take the pathNode.index when I = 0
    if (pathNode.index + i < siblingElements.length)
    {
      var item = siblingElements.item(pathNode.index + i);
      setBestPathNodeRecord(pathNode, bestPathNodeRecord, item);
      // break if node search failed or score is max
      if (bestPathNodeRecord.score === pathNode.maxScore)
        break;
    }
    // Go down
    if (pathNode.index - i >= 0 &&
      i != 0 &&
      pathNode.index - 1 < siblingElements.length)
    {
      item = siblingElements.item(pathNode.index - i);
      setBestPathNodeRecord(pathNode, bestPathNodeRecord, item)
      // break if node search failed or score is max
      if (bestPathNodeRecord.score === pathNode.maxScore)
        break;
    }
  }
  return bestPathNodeRecord;
};
```

The getBestMatchRecord function calls the setBestPathNodeRecord function, which is included below.

```
  setBestPathNodeRecord = function (pathNode, bestPathNodeRecord, item)
  {
    var failed = true;
    var pathScore = getElementSimilarityScore(pathNode, item);
    if (pathScore >= 0)
    {
      var nextNode = pathNode.nextNode;
      if (nextNode)
      {
        var nextPathNodeRecord = getBestMatchRecord(nextNode, item);
        if (nextPathNodeRecord.score >= 0)
      {
        failed = false;
        pathScore += nextPathNodeRecord.score;
        if (pathScore > bestPathNodeRecord.score)
        {
          bestPathNodeRecord.bestElem = nextPathNodeRecord.bestElem;
          bestPathNodeRecord.score = pathScore;
        }
      }
    }
    else
    {
      failed = false;
      if (pathScore > bestPathNodeRecord.score)
      {
        bestPathNodeRecord.bestElem = item;
        bestPathNodeRecord.score = pathScore;
      }
    }
  }
  return !failed;
};
```

The setBestPathNodeRecord function calls the getElementSimilarityScore function and getElementSimilarityScore_helper function.

```
  getElementSimilarityScore = function (pathNode, elem)
  {
    var score = -1;
    if (elem.nodeName === pathNode.nodeName)
    {
      var elementInfo = new PathNode(elem, pathNode.text !== null,
  pathNode.childDepth);
      score = getElementSimilarityScore_helper(pathNode, elementInfo);
    }
    return score;
  };
  getElementSimilarityScore_helper = function (pathNode, elementInfo)
  {
    var score = 0;
    if (pathNode.nodeName === elementInfo.nodeName)
  {
    if (pathNode.text != null)
      score += pathNode.text === elementInfo.text ? 1 : 0;
    if (Object.keys(pathNode.attrs).length ===
Object.keys(elementInfo.attrs).length)
      score++;
    for (var key in pathNode.attrs)
    {
      var localValue = elementInfo.attrs[key];
      if (localValue !== undefined)
        score += localValue === pathNode.attrs[key] ? 1 : 0;
    }
    //Children
    if (score >= 0 && pathNode.children)
    {
      for (var i = 0; i < pathNode.children.length && i <
elementInfo.children.length; i++)
      {
        var childScore =
          getElementSimilarityScore_helper(pathNode.children[i],
elementInfo.children[i]);
        if (childScore > 0)
          score += childScore;
      }
    }
  }
  else
    score = -1;
  return score;
};
```

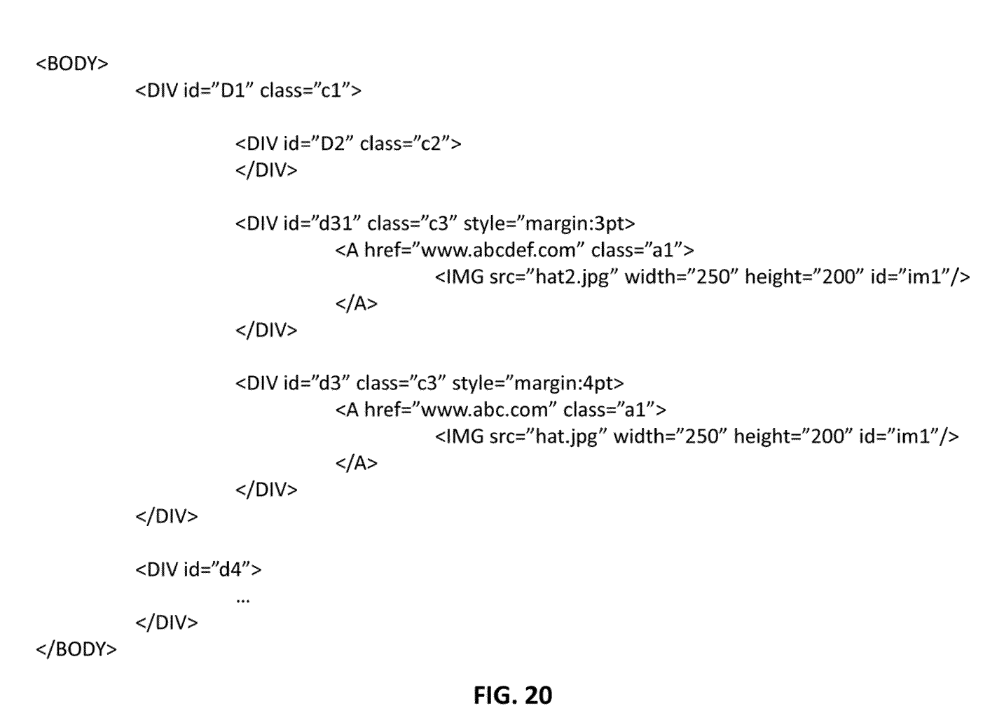

FIG. 20 sets forth example HTML code that may be executed by the friend's cobrowser in accordance with the example discussed earlier. Although the user's and friend's cobrowsers may be pointing to the same web page address, the actual web object displayed in the web page in each cobrowser may come from a different source, e.g., the web object may be the third child of the parent web page from the user instead of the second child of the parent web page from the perspective of the friend.

In the embodiment illustrated in FIG. 20, the invention may first start searching with the first child from <BODY>. Second, after searching the first child, it may then consider the second child of the DIV with id=dl (since the NodePath information received the path to consider is the node with index=2). This is the wrong path, which needs to be corrected. Third, it finishes this path with a score that will not be 100% because some of the attributes do not match. Example: id=d31 instead of id=3 and href=“www.abcdef.com” instead of www.abc.com. Fourth, it considers the other path starting with siblings that are close (the one above and below) to the 2^{nd} child. It will therefore consider the DIV with id=d3 (which is the right one) and end up with a higher score even though it will not be 100%, because style=“margin:4pt” instead of apt in the case of the sender's HTML. Fifth, based on the better score, the winner will be the third child, meaning the right object.

### 7. State Replication on Connection

Another embodiment of the invention relates to state replication on a connection. Prior to initiating a cobrowsing session, a user may interact with a web page in a cobrowser and modify it before inviting a friend to join a cobrowsing session on that page. Examples of web page modifications include scrolling, ticking a checkbox, and selecting an option from a pull-down menu.

Upon opening a second user's cobrowser (i.e., the second user accepting an invitation to enter into a cobrowsing session with a first user), the second user's cobrowser may need to ensure the same page modifications are replicated from the first user's cobrowser. The replication of the state of the web page should be defined as the state of the web page prior to sending the invitation.

For example, a user may navigate to an online store website before inviting a friend to join a cobrowsing session. The user may then navigate to a page on that website displaying information on a white hat. If the web page enables the user to select different colors for the hat through a pull-down menu, the user may interact with the menu to change the color of the hat to blue from white. Based on the selection in the pull-down menu, the web page may display an image of a blue hat. Additionally, the user may also scroll down the page to better see the options available.

Having found the desired hat and color, the user may decide to invite a friend for a cobrowsing session. When the friend's cobrowser connects, it may automatically navigate to the same page. In prior art methods, the web page on the friend's cobrowser, however, does not reflect the changes made by the user. Thus, the cobrowser may only show the initial view of the web page, where the white hat is displayed, and the page displayed on the friend's cobrowser does not reflect any downward scrolling or the selection of the blue hat by the user.

According to an embodiment of the invention, this problem is solved. Information on the “state” of the web page received at connection time allows the friend's cobrowser to “catch up” by executing the same actions one after another and in the same order as on the user's cobrowser. Continuing the example discussed earlier, the friend's cobrowser may update the value of the pull-down menu, causing the page to display a blue hat, then scroll down to the same position as the user's cobrowser.

The friend joining the cobrowsing session may notice changes happening on the web page immediately after connecting, but does not have to manually intervene to synchronize his or her cobrowser. The friend, for example, may see the pull-down menu value changing to blue along with the picture of the hat and the page scrolling down immediately after connecting to the cobrowser.

The mechanics of updating the state of the friend's cobrowser incorporates the use of several steps. When inviting a friend, a handshake occurs to establish the cobrowsing connection. During the handshake, the state information from the initial cobrowser is communicated to the new user's device entering the session. State information may be recorded in an array that logs actions taken by a user. For example, the array may log scrolling activities, selecting from a form component, or clicking activities on web objects. Thus, the array of actions may define the state of the page.

Upon connecting by the friend's cobrowser, the friend's cobrowser may review the state array and execute the actions one after the other with a short time interval between each. If, during the restoring of the state, new actions are received (new changes by other users), the cobrowser adds them to the state array (queues them up), which ensures that all actions get processed.

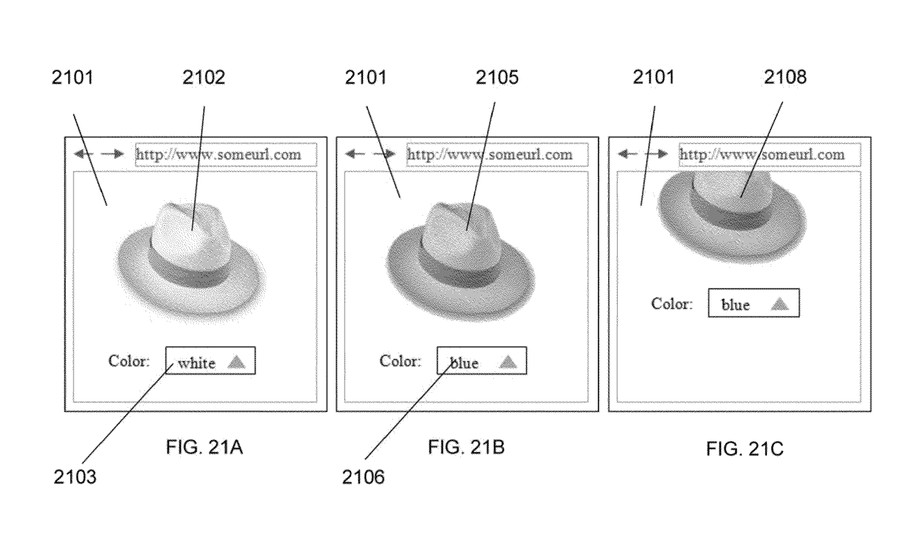

FIGS. 21A through 21C illustrate an example of state restoration at the start of a cobrowsing session on the friend's cobrowser. As shown in FIG. 21A, the cobrowser 2101 initially shows a white hat 2102 based on the selection of pull-down menu 2103 being “white.” As shown in FIG. 21B, the cobrowser 2101 next shows a blue hat 2105 based on the selection of pull-down menu 2106 being “blue.” As discussed above, the cobrowser 2101 may make this selection based on information in the state array. As shown in FIG. 21C, the cobrowser 2107 next shows a blue hat 2108 translated upwards to reflect a downward scroll by the user.

After synchronizing the web page at start-up, the friend's cobrowser may continue to track all further actions by the user or inbound from other users through logging the actions in the state array.

It is to be understood that the disclosed subject matter is not limited in its application to the details of construction and to the arrangements of the components set forth in the foregoing description or illustrated in the drawings. The disclosed subject matter is capable of other embodiments and of being practiced and carried out in various ways. Also, it is to be understood that the phraseology and terminology employed herein are for the purpose of description and should not be regarded as limiting.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A method for adding a note to an existing website comprising:
(a) receiving a request at a browser to add a note associated with an object of a web page of the existing website;
(b) displaying the note on top of the object on the web page; and
(c) assembling a record for the note, wherein the record includes identification information for the object and information regarding content of the note, wherein the record is usable to reproduce the note on the web page of the existing website.

2. The method of claim 1, further comprising saving the record at the browser for use at a later time.

3. The method of claim 1, further comprising presenting a menu of predefined notes for selection by a user.

4. The method of claim 1, further comprising presenting a menu of notes for selection by a user, wherein the notes are at least partially customizable.

5. The method of claim 1, further comprising sending a message from the browser for use at a second browser, wherein the message comprises the record.

6. The method of claim 5, wherein the message is usable to retrieve the web page and display the note on top of the object.

7. The method of claim 5, wherein the message is sent to a computing system.

8. The method of claim 5, wherein the message comprises one or more of accompanying text, size information, color information, and sound information for the note.

9. The method of claim 8, wherein the message comprises text that is at least partially customizable by a user.

10. A method for adding a note to an existing website in a cobrowser context comprising:
(a) establishing from a first computing device a cobrowsing session between at least the first computing device and a second computing device, wherein the first computing device and second computing device each include a cobrowser that can reflect interactions with and remain synchronized with the cobrowser on the other computing device;
(b) receiving a request at the first computing device to add a note associated with an object of a web page of the existing website; and
(c) assembling a message at the first computing device for the note, wherein the message includes identification information for the object and information regarding content of the note.

11. The method of claim 10, further comprising sending the message to the second computing device to display the note above the object on the web page of the existing website.

12. The method of claim 10, wherein the message further includes one or more of accompanying text, size information, color information, and sound information for the note.

13. The method of claim 10, further comprising presenting at the first computing device a menu of predefined notes for selection by a user.

14. The method of claim 10, wherein the message comprises text that is at least partially customizable by a user.

15. A method for using a note for a website comprising:
(a) receiving a message from a first computing device for a note, wherein the note is associated with an object of a web page of the website, the message including identification information for the object, information regarding content for the note, and an indication of one or more targeted users for the note;
(b) storing the message; and
(c) sending information from the message to at least one targeted computing device for a targeted user, wherein the information is sufficient to allow a browser installed on the target computing device to display the note above the object.

16. The method of claim 15, wherein the message is stored in a database entry that is linked to an account for the targeted user.

17. The method of claim 15, further comprising receiving a signal from the targeted computing device relating to a web page address, wherein the sending of the information from the message occurs in response to the signal.

18. A non-transitory computer readable medium containing instructions that, when executed, allow a computing device to perform the following steps for adding a note to an existing website:
(a) receiving a request at the computing device to add a note associated with an object of a web page of the existing website;
(b) displaying the note on top of the object on the web page; and
(c) assembling a record at the computing device for the note, wherein the record includes identification information for the object and information regarding content of the note, wherein the record is usable to reproduce the note on the web page of the existing website.

19. The non-transitory computer readable medium of claim 18, further comprising executable instructions operable to cause the computing device to save the record at the computing device for use at a later time.

20. The non-transitory computer readable medium of claim 18, further comprising executable instructions operable to cause the computing device to present a menu of predefined notes for selection by a user.

21. The non-transitory computer readable medium of claim 18, further comprising executable instructions operable to cause the computing device to send a message from the browser for use at a second browser, wherein the message comprises the record.

22. The non-transitory computer readable medium of claim 18, wherein the message is usable to retrieve the web page and display the note above the object.

23. A non-transitory computer readable medium containing instructions that, when executed, allow a first computing device to perform the following steps for adding a note to an existing website in a cobrowser context:
(a) establishing from the first computing device a cobrowsing session between at least the first computing device and a second computing device, wherein the first computing device and second computing device each include a cobrowser that can reflect interactions with and remain synchronized with the other computing device's cobrowser;
(b) receiving a request at the first computing device to add a note associated with an object of a web page of the existing website; and
(c) assembling a message at the first computing device for the note, wherein the message includes identification information for the object and information regarding content of the note.

24. The non-transitory computer readable medium of claim 23, further comprising executable instructions operable to cause the first computing device to present at the first computing device a menu of predefined notes for selection by a user of the first computing device.

25. The non-transitory computer readable medium of claim 23, wherein the message further includes one or more of accompanying text, size information, color information, and sound information for the note.

26. A non-transitory computer readable medium containing instructions that, when executed, allow a computing device to perform the following steps for using a note for a website:
(a) receiving a message from a first computing device for a note, wherein the note is associated with an object of a web page of the website, the message including identification information for the object, information regarding content for the note, and an indication of one or more targeted users for the note;
(b) storing the message; and
(c) sending information from the message to at least one targeted computing device, wherein the information is sufficient to allow a browser installed on the target computing device to display the note above the object.

27. The non-transitory computer readable medium of claim 26, further comprising executable instructions operable to cause the computing device to receive a signal from the targeted computing device, wherein the sending of the information from the message occurs in response to receiving the signal.
